(19) United States
(12) Patent Application Publication
(10) Pub. No.: US 2015/0382285 A1
(43) Pub. Date: Dec. 31, 2015

(54) OTHER RADIO ACCESS TECHNOLOGY SEARCH INSIDE A GSM TUNE-AWAY GAP IN MULTI-SIM DEVICES

(71) Applicant: QUALCOMM Incorporated, San Diego, CA (US)

(72) Inventors: Raghavendra Shyam Anand, Hyderabad (IN); Parthasarathy Krishnamoorthy, Hyderabad (IN); Anand Rajurkar, Hyderabad (IN)

(21) Appl. No.: 14/316,028

(22) Filed: Jun. 26, 2014

(51) Int. Cl. H04W 48/16; H04W 88/06; H04W 36/00

(52) U.S. Cl. CPC H04W 48/16; H04W 36/0061; H04W 88/06

(57) ABSTRACT

A mobile communication device, includes: a radio frequency (RF) receive chain; a control unit configured to tune the RF receive chain to receive signals from one of a first radio access technology (RAT) and a second RAT different from the first RAT; and a first signal modification unit configured to modify the signals received from the first RAT. The control unit is further configured to suspend operation of the first signal modification unit when the RF receive chain is tuned to receive signals on the second RAT.

### BACKGROUND

In a Dual-Subscriber Identity Module (SIM), Dual-Standby (DSDS) user equipment (UE), i.e., a mobile communication device, using Wideband Code Division Multiple Access (WCDMA) and Global System for Mobile communications (GSM) radio access technologies (RATs), each of the RATs must perform search and measurement of signals from neighboring base stations. For example, during an active call, the WCDMA RAT needs to search during its active timeslots to identify an appropriate cell for handover while the idle GSM RAT must wake up to receive network pages and also search for neighboring cells.

To perform a cell search, each RAT requires exclusive control of the radio frequency (RF) receive chain for a continuous time period necessary to perform the search and measurement. The RF receive chain must tune to the RAT performing the search. However, the tune away period for GSM search and measurement may interfere with the continuous time needed for WCDMA to schedule its cell search. Accordingly, the WCDMA search may be postponed until absolutely necessary, for example, until WCDMA is in danger of dropping a call. As a result, the GSM search may be preempted resulting in missing the GSM page bursts. WCDMA performance will be degraded by postponing its cell search and/or GSM performance will be degraded by missing its page bursts.

### SUMMARY

Apparatuses and methods for performing cell search are provided.

According to various embodiments there is provided a mobile communication device. The mobile communication device may include: a radio frequency (RF) receive chain; a control unit configured to tune the RF receive chain to receive signals from one of a first radio access technology (RAT) and a second RAT different from the first RAT; and a first signal modification unit configured to modify the signals received from the first RAT. The control unit may be further configured to suspend operation of the first signal modification unit when the RF receive chain is tuned to receive signals on the second RAT.

According to various embodiments there is provided a method for performing cell search. The method may include: tuning an RF receive chain to receive signals from one of a first radio access technology (RAT) and a second RAT different from the first RAT; modifying the signals received from the first RAT; and suspending modification of the first RAT signals when the RF receive chain is tuned to receive signals on the second RAT.

According to various embodiments there is provided a cell search method. The cell search method may include: scheduling a cell search for a first radio access technology (RAT) over a first predetermined number of timeslots for non-coherent accumulation; performing coherent accumulation of cell signature energy for one or more signals on the first RAT during a coherent accumulation length of a current timeslot; determining whether a next timeslot is a timeslot for tune-away to a second RAT; suspending automatic gain control for the one or more signals on the first RAT during a timeslot determined to be a tune-away timeslot; and performing non-coherent accumulation of cell signature energy for the first RAT over the first predetermined number of timeslots.

According to various embodiments there is provided method for performing cell search. The method may include: performing a coherent accumulation of cell signature energy of signals from a first radio access technology (RAT) for a coherent accumulation length during each of a first predetermined number of timeslots; minimizing the coherent accumulation of cell signature energy for the first RAT during a second predetermined number of timeslots; and performing non-coherent accumulation of the coherent accumulations of signature energy for the first RAT over the first predetermined number of timeslots. The second predetermined number of timeslots is a subset of the first predetermined number of timeslots.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2 is a block diagram illustrating a communications unit for a mobile communication device according to various embodiments;

FIG. 3 is a diagram illustrating a radio frame according to various embodiments;

FIG. 4 is a diagram illustrating a series of timeslots of a radio frame including tune-away timeslots according to various embodiments;

FIG. 5 is a flowchart a method according to various embodiments; and

FIG. 6 is a flowchart illustrating a method according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

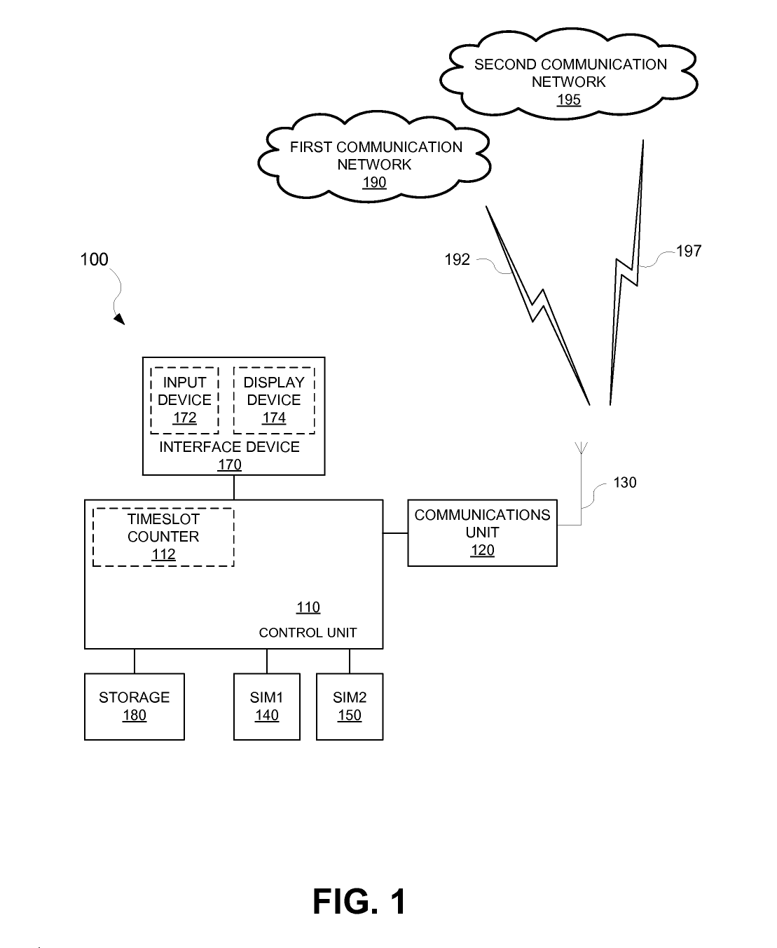

FIG. 1 is a block diagram illustrating a mobile communication device 100 according to various embodiments. The mobile communication device 100 may be, for example but not limited to, a mobile telephone, smartphone, tablet, computer, etc., capable of communications with one or more wireless networks. As illustrated in FIG. 1, the mobile communication device 100 may include a control unit 110, a timeslot counter 112, a communications unit 120, an antenna 130, a first SIM 140, a second SIM 150, a user interface device 170, and a storage 180.

The first SIM 140 may associate the communications unit 120 with a first RAT 192, for example, but not limited to, WCDMA, on a first communication network 190 and the second SIM 150 may associate the communications unit 120 with a second RAT 197, for example, but not limited to, GSM, on a second communication network 195. When a RAT is active, the communications unit 120 receives and transmits signals on the active RAT. When a RAT is idle, the communications unit 120 receives but does not transmit signals on the idle RAT.

For convenience, throughout this disclosure WCDMA is referred to as the first RAT 192 and GSM is referred to as the second RAT 197. One of ordinary skill in the art will appreciate that the various embodiments will apply to other RATs without departing from the scope of the present inventive concept.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may control overall operation of the mobile communication device 100 including control of the communications unit 120, the user interface device 170, and the storage 180. The control unit 110 may be a programmable device, for example, but not limited to, a microprocessor or microcontroller.

The timeslot counter 112 may be implemented as hardware internal or external to the control unit 110 or as software, or as a combination of hardware and software.

The storage 180 may store application programs necessary for operation of the mobile communication device 100 that are executed by the control unit 110, as well as application data and user data.

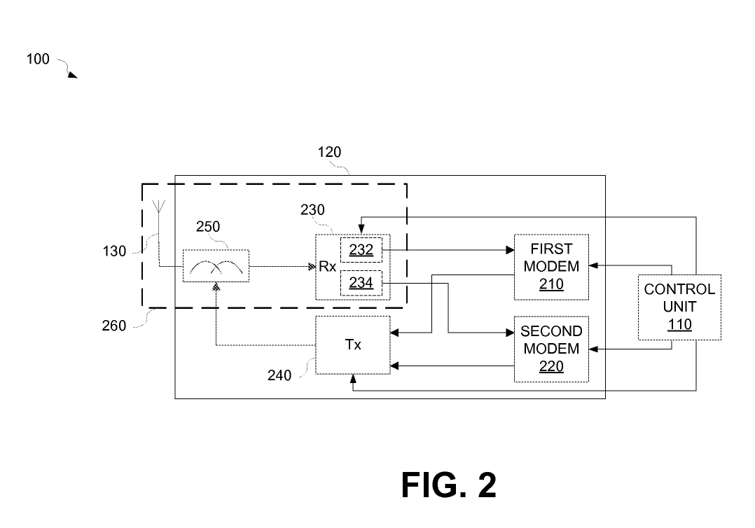

FIG. 2 is a block diagram illustrating the communications unit 120 (e.g., refer to FIG. 1) for a mobile communication device (e.g., the wireless communication device 100 of FIG. 1) according to various embodiments. With reference to FIGS. 1 and 2, the communications unit 120 may include a first modem 210, a second modem 220, a receiver 230, a transmitter 240, and a duplexer 250. The receiver 230 may be configured to receive signals on the first RAT 192 and the second RAT 197. The receiver 230 may include a first signal modification unit 232 that may be configured to modify signals received on the first RAT 192, and a second signal modification unit 234 that may be configured to modify signals received on the second RAT 197. The first and second signal modification units 232, 234 may be, for example, but not limited to, automatic gain control (AGC) units that may be configured to amplify received first and second RAT 192, 197 signals, respectively. The duplexer 250 may couple transmit and receive signals to the antenna 130. An RF receive chain 260 may include the antenna 130, the duplexer 250, and the receiver 230.

The first modem 210 may be configured to process signals from the first RAT 192, for example, but not limited to, WCDMA. The second modem 220 may be configured to process signals from the second RAT 197, for example, but not limited to, GSM. Alternatively, the first modem 210 or the second modem 220 may be configured to process signals from both the first RAT 192 and the second RAT 197.

During cell search, the mobile communication device 100 determines the downlink scrambling code and common channel frame synchronization of a cell. The mobile communication device 100 uses the synchronization channel (SCH) primary synchronization code to acquire slot synchronization to a cell. The mobile communication device 100 uses the SCH secondary synchronization code to find frame synchronization and identify the code group of the cell by correlating the received signal with all possible secondary synchronization code sequences and identifying the maximum correlation value.

Finally, the mobile communication device 100 determines the primary scrambling code used by the cell through symbol-by-symbol correlation over the common pilot channel (CPICH) with all codes within the identified code group. By identifying the primary scrambling code, the primary common control physical channel (P-CCPCH) can be detected and the system-specific and cell-specific broadcast channel (BCH) information can be read by the mobile communication device 100. Completion of the cell search process requires approximately 120 mS.

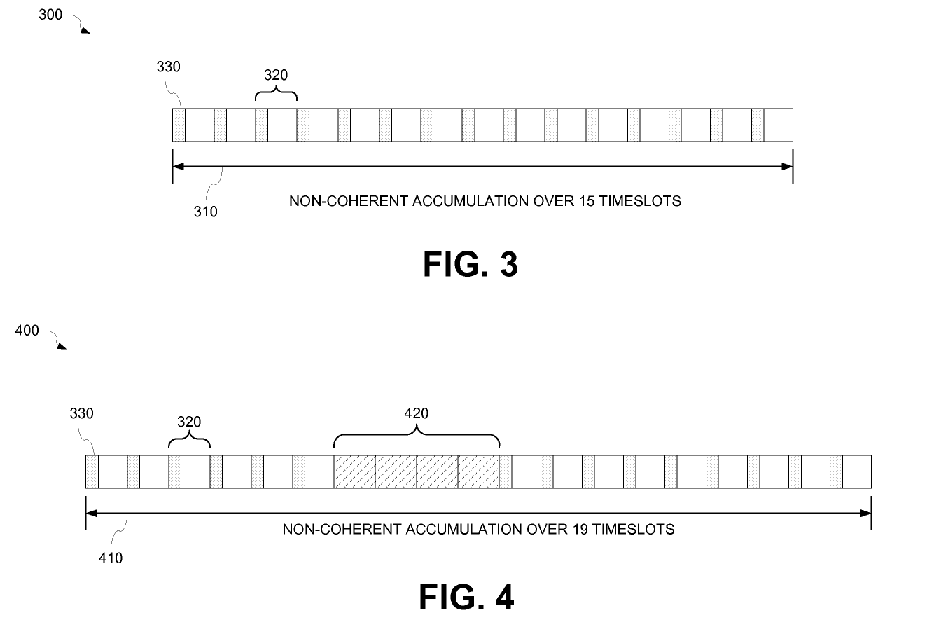

FIG. 3 is a diagram 300 illustrating a radio frame 310 according to various embodiments. Referring to FIGS. 1-3, the radio frame 310 may include a series of timeslots 320. Each timeslot 320 may have a duration of 667 μS (equal to a length of 2560 chips). One radio frame 310 may contain a fixed number of time slots 320, for example fifteen timeslots 320, for a radio frame 310 length of 10 mS. A cell signature, for example, the primary synchronization code (PSC) for WCDMA or the primary synchronization signal (PSS) for LTE, may be transmitted as a 256 bit code by a network (e.g., the first communication network 190 and/or the second communication network 195) on the SCH at the beginning of every timeslot 320.

During the RAT cell search, the control unit 110 may cause the signature energy of a cell to be accumulated coherently by the mobile communication device 100 during short coherent accumulation lengths (for example, approximately 67 μS) 330 in each of the timeslots 320. During coherent accumulation, the phase of the energy signals may be synchronized. The cell signature energy accumulated during coherent accumulation lengths 330 may be added non-coherently (i.e., the results of the coherent accumulations are added together) by the mobile communication device 100 over a plurality, for example, fifteen (or other suitable number), of timeslots 320 to increase a Signal-to-Noise Ratio (SNR) of a detection decision statistic. Cell search requires exclusive control of the RF receive chain 260 by the RAT for the approximately 120 mS duration of the search.

For a mobile communication device 100 that is a DSDS mobile communication device that supports a first RAT 192 and a second RAT 197, one of the first RAT 192 and the second RAT 197 may be in an active mode, for example on a voice or data call, while the other RAT is in an idle mode. For example, the first RAT 192 may be in an active mode on the first communication network 190 and the second RAT 197 may be in an idle mode. The first RAT 192 may be, for example, but not limited to, WCDMA, and the second RAT 197 may be, for example, but not limited to, GSM. While in the idle mode, the second RAT 197 may wake up periodically in accordance with a discontinuous receive (DRX) cycle in order to receive pages from the second communication network 195.

For the second RAT 197 to receive pages from the second communication network 195, activity of the first RAT 192 on the first communication network 190 may be interrupted and the RF receive chain 260 of the communications unit 120 tuned away from the first RAT 192 to the second RAT 197 for a period of time, for example four timeslots, sufficient for the second RAT 197 to receive and decode the page from the second communication network 195. The period of time during which the activity of the first RAT 192 on the first communication network 190 is interrupted is referred to herein as a tune-away period.

Since cell search by the first RAT 192 requires exclusive control of the RF receive chain 260 by the first RAT 192 for the duration (e.g., approximately 120 mS) of the search, the periodic wake-up and tune-away for the second RAT 197 to receive pages in accordance with its DRX cycle may interfere with scheduling of the first RAT 192 cell search. In particular, the mobile communication device 100 may be unable to schedule a sufficient period of exclusive control of the RF receive chain 260 for the first RAT 192 to perform a necessary number of coherent accumulations of cell signature energy to increase the Signal-to-Noise Ratio (SNR) of the detection decision statistic to identify a cell.

FIG. 4 is a diagram 400 illustrating a series of timeslots 320 of a radio frame 410 including tune-away timeslots 420 according to various embodiments. Referring to FIGS. 1, 2, and 4, in various embodiments, a cell signature detection algorithm may increase the number of timeslots 320, for example from fifteen timeslots 320 to nineteen timeslots 320, for coherent accumulation of cell signature energy during the coherent accumulation lengths 330 in each of the timeslots 320 for the first RAT 192, and non-coherent accumulation of the coherently accumulated cell signature energy may be performed over the increased number of timeslots 320.

The increased number of timeslots 320 for accumulation of cell signature energy may allow scheduling of cell search for the first RAT 192 over tune-away timeslots 420 during which tune-away from the first RAT 192 to the second RAT 197 occurs.

In various embodiments, accumulation of cell signature energy for the first RAT 192 during the tune-away timeslots 420 may be minimized. The DRX cycle of the second RAT 197 is known to the mobile communication device 100; therefore, the temporal position of the tune-away timeslots 420 is also known. During the tune-away timeslots 420 for the second RAT 197, the control unit 110 may minimize the effect from second RAT 197 signals received by the RF receive chain 260 on the accumulation of cell signature energy for the first RAT 192 by suspending operation of the first AGC unit 232. By suspending operation of the first AGC unit 232 during the tune-away timeslots 420, the SNR of symbols received during the second RAT 197 tune-away timeslots 420 will not be amplified and accumulated as cell signature energy during the first RAT 192 cell search.

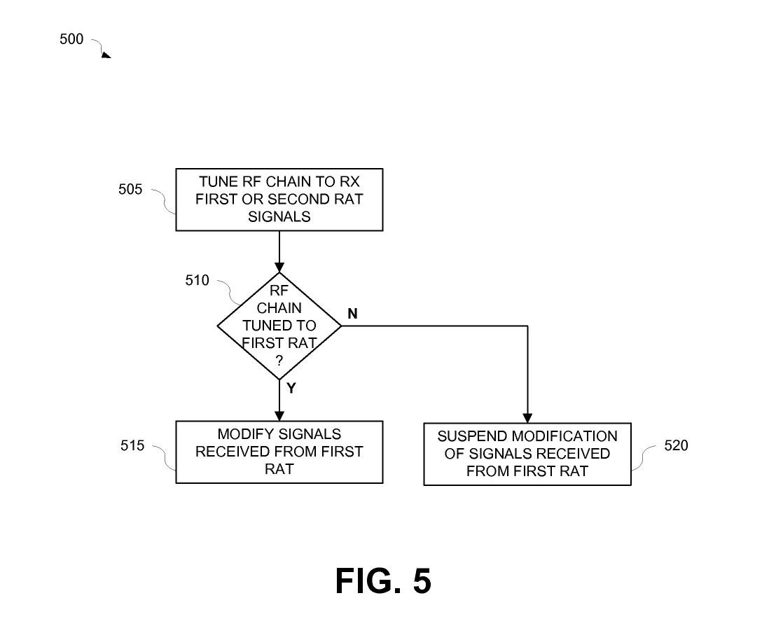

FIG. 5 is a flowchart 500 illustrating a method according to various embodiments. Referring to FIGS. 1-5, the control unit 110 may cause the RF chain to receive signals on the first RAT 192 or the second RAT 197 (505). If the RF chain is tuned to receive signals on the first RAT 192 (510-Y), the control unit 110 may cause the first signal modification unit 232 to modify the signals received from the first RAT 192 (515). For example, the first signal modification unit 232 may apply automatic gain control to the signals received from the first RAT 192.

If the RF chain is not tuned to receive signals on the first RAT 192 (510-N), i.e., the control unit 110 causes the RF chain to receive signals on the second RAT 197, the control unit 110 may cause the first signal modification unit 232 to suspend operations of modifying the signals received from the first RAT 192 (520).

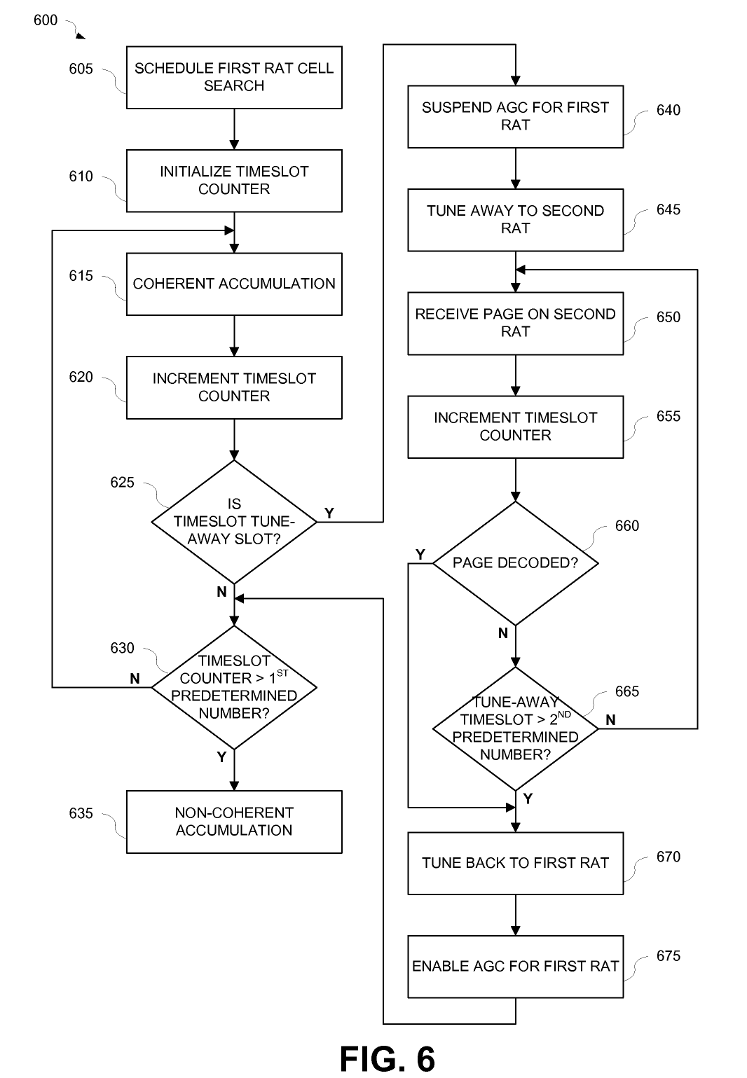

FIG. 6 is a flowchart 600 illustrating a method according to various embodiments. Referring to FIGS. 1-4 and 6, the control unit 110 may schedule cell search for the first RAT 192 over a first predetermined number of timeslots for non-coherent accumulation (605) and initialize a timeslot counter 112 (610). The control unit 110 may cause a coherent accumulation of cell signature energy for one or more signals on the first RAT 192 to be performed during a coherent accumulation length 330 of a current timeslot 320 (615). After the coherent accumulation of the cell signature energy for the one or more first RAT 192 signals in the current timeslot 320, the control unit 110 may increment the timeslot counter 112 (620).

Since the DRX cycle of the second RAT 197 and the temporal position of the tune-away timeslots 420 are known, the control unit 110 may determine whether the timeslot 320 corresponding to the incremented timeslot counter 112 value is a tune-away timeslot 420 (625). If the timeslot 320 corresponding to the incremented timeslot counter 112 value is not a tune-away timeslot 420 (625-N), the control unit 110 may determine whether the incremented value of the timeslot counter 112 is greater than the first predetermined number of timeslots 320 for non-coherent accumulation (630).

If the incremented value of the timeslot counter 112 is not greater than the first predetermined number of timeslots 320 for non-coherent accumulation (630-N), the process of coherent accumulation continues (615). If the incremented value of the timeslot counter 112 is greater than the first predetermined number of timeslots 320 for non-coherent accumulation (630-Y), non-coherent accumulation is performed over the first predetermined number of timeslots for non-coherent accumulation (635).

If the timeslot 320 corresponding to the incremented timeslot counter 112 value is a tune-away timeslot 420 (625-Y), the control unit 110 may suspend operation of the first AGC unit 232 for the first RAT 192 (640), and cause the RF receive chain 260 to tune away to the second RAT 197 (645). A page may be received on the second RAT 197 (650) during the tune-away timeslot 420, and the control unit 110 may increment the timeslot counter 112 (655). The control unit may then determine whether the received page was successfully decoded (660). If the page on the second RAT 197 was not successfully decoded (660-N), the control unit 110 may determine whether the number of tune-away timeslots 420 is greater than the second predetermined number of tune-away timeslots 420 for the second RAT 197 (665). The second predetermined number of tune-away timeslots 420 for the second RAT 197 may be, for example, four tune-away timeslots 420 with one page in each of four successive tune-away timeslots 420.

If the number of tune-away timeslots 420 for the second RAT 197 is not greater than the second predetermined number of tune-away timeslots 420 (665-N), another page may be received on the second RAT 197 (650). If the page is successfully decoded (660-Y) or the number of tune-away timeslots 420 for the second RAT 197 is greater than the second predetermined number of tune-away timeslots 420 (665-Y), the control unit 110 may cause the RF receive chain 260 to tune back to the first RAT 192 (670) and enable operation of the first AGC unit 232 for the first RAT 192 (675). Accordingly, the control unit 110 may determine whether the incremented value of the timeslot counter 112 is greater than the first predetermined number of timeslots 320 for non-coherent accumulation (630).

If the incremented value of the timeslot counter 112 is not greater than the first predetermined number of timeslots 320 for non-coherent accumulation (630-N), the process of coherent accumulation continues (615). If the incremented value of the timeslot counter 112 is greater than the first predetermined number of timeslots 320 for non-coherent accumulation (630-Y), non-coherent accumulation is performed over the selected number of timeslots 320 for non-coherent accumulation (635).

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A mobile communication device, comprising:
a radio frequency (RF) receive chain;
a control unit configured to tune the RF receive chain to receive signals from one of a first radio access technology (RAT) and a second RAT different from the first RAT; and
a first signal modification unit configured to modify the signals received from the first RAT,
wherein the control unit is further configured to suspend operation of the first signal modification unit when the RF receive chain is tuned to receive signals on the second RAT.

2. The mobile communication device of claim 1, wherein the first signal modification unit comprises an automatic gain control (AGC) unit configured to amplify the signals received from the first RAT.

3. The mobile communication device of claim 1, wherein
the RF receive chain comprises an antenna and a receiver; and
the control unit is configured to tune the receiver to receive the signals from one of the first RAT and the second RAT based on a discontinuous receive cycle of the second RAT.

4. The mobile communication device of claim 3, wherein the control unit is configured to tune the receiver to receive the signals on the second RAT during a predetermined number of timeslots corresponding to a tune-away period to the second RAT.

5. The mobile communication device of claim 4, wherein the predetermined number of timeslots corresponding to a tune-away period to the second RAT is less than a first predetermined number of time slots.

6. The mobile communication device of claim 5, wherein the first predetermined number of timeslots is greater than a number of timeslots in a radio frame by a first amount, and
wherein the control unit is configured to perform non-coherent accumulation of cell signature energy for the first RAT over the first predetermined number of timeslots.

7. A method for performing cell search, the method comprising:
tuning an RF receive chain to receive signals from one of a first radio access technology (RAT) and a second RAT different from the first RAT;
modifying the signals received from the first RAT; and
suspending modification of the first RAT signals when the RF receive chain is tuned to receive signals on the second RAT.

8. The method of claim 7, wherein the modifying the signals received from the first RAT comprises applying automatic gain control to the signals received from the first RAT.

9. The method of claim 7, wherein the tuning an RF receive chain comprises tuning a receiver to receive the signals from one of the first RAT and the second RAT based on a discontinuous receive cycle of the second RAT.

10. The method of claim 9, wherein the tuning an RF receive chain further comprises tuning the receiver to receive the signals on the second RAT during a predetermined number of timeslots corresponding to a tune-away period to the second RAT.

11. The method of claim 10, wherein the predetermined number of timeslots corresponding to a tune-away period to the second RAT is less than a first predetermined number of time slots.

12. The method of claim 11, wherein the first predetermined number of timeslots is greater than a number of timeslots in a radio frame by a first amount, and
the method further comprises performing non-coherent accumulation of cell signature energy for the first RAT over the first predetermined number of timeslots.

13. A cell search method, comprising:
scheduling a cell search for a first radio access technology (RAT) over a first predetermined number of timeslots for non-coherent accumulation;
performing coherent accumulation of cell signature energy for one or more signals on the first RAT during a coherent accumulation length of a current timeslot;
determining whether a next timeslot is a timeslot for tune-away to a second RAT;
suspending automatic gain control for the one or more signals on the first RAT during a timeslot determined to be a tune-away timeslot; and
performing non-coherent accumulation of cell signature energy for the first RAT over the first predetermined number of timeslots.

14. The method of claim 13, wherein the one or more timeslots for tune-away to a second RAT is less than or equal to a second predetermined number of timeslots, and
the second predetermined number of timeslots is a subset of the first predetermined number of timeslots.

15. The method of claim 14, further comprising enabling automatic gain control for the one or more signals on the first RAT after a page on the second RAT is successfully decoded or the page on the second RAT is not successfully decoded within the second predetermined number of timeslots.

16. The method of claim 13, further comprising enabling automatic gain control for the one or more signals on the first RAT after a page on the second RAT is successfully decoded or the page on the second RAT is not successfully decoded within a second predetermined number of timeslots.

17. The method of claim 13, further comprising tuning away to the second RAT when a next timeslot is determined to be a timeslot for tune-away to the second RAT.

18. The method of claim 17, further comprising:
receiving a page on the second RAT; and
decoding the received page.

19. The method of claim 18, further comprising:
receiving another page if the received page is not successfully decoded and more than a second predetermined number of tune away timeslots has not been counted; and
tuning back to the first RAT if the received page is successfully decoded or more than a second predetermined number of tune away timeslots has been counted.

20. The method of claim 13, wherein the first RAT is different from the second RAT.

21. The method of claim 14, wherein the first predetermined number of time slots is greater than a number of timeslots in radio frame by a first amount.

22. The method of claim 14, wherein the second predetermined number of timeslots is less than the first predetermined number of time slots.

23. A method for performing cell search, the method comprising:
performing a coherent accumulation of cell signature energy of signals from a first radio access technology (RAT) for a coherent accumulation length during each of a first predetermined number of timeslots;
minimizing the coherent accumulation of cell signature energy for the first RAT during a second predetermined number of timeslots; and
performing non-coherent accumulation of the coherent accumulations of signature energy for the first RAT over the first predetermined number of timeslots,
wherein the second predetermined number of timeslots is a subset of the first predetermined number of timeslots.

24. The method of claim 23, wherein the second predetermined number of timeslots corresponds to a tune-away period to a second RAT.

25. The method of claim 23, wherein automatic gain control for the first RAT is suspended during the second predetermined number of timeslots corresponding to the tune-away period to the second RAT.

26. The method of claim 23, wherein the first RAT is different from the second RAT.

27. The method of claim 23, wherein the first predetermined number of timeslots is greater than a number of timeslots in radio frame by a first amount.

28. The method of claim 23, wherein the second predetermined number of timeslots is less than the first predetermined number of time slots.
